(19) United States
(12) Patent Application Publication
(10) Pub. No.: US 2003/0126191 A1
(43) Pub. Date: Jul. 3, 2003

(54) System and method for distributing process-related information in a multiple node network

(75) Inventors: Robert Hofner, Ashdod (IL); Yuval Yeret, Tel Aviv (IL)

Correspondence Address: SUGHRUE MION, PLLC, 2100 PENNSYLVANIA AVENUE, N.W., WASHINGTON, DC, 20037, US

(73) Assignee: Exanet, Ltd. (a USA corporation)

(21) Appl. No.: 10/032,479

(22) Filed: Jan. 2, 2002

(51) Int. Cl. G06F 15/16

(52) U.S. Cl. 709/202; 709/207; 709/206

(57) ABSTRACT

A system and method are provided for distributing information between processes executing on a computer node and across clusters of computer nodes. The system also provides for querying the system database to request historical system information. A process can receive specific information by registering in the system database under a category that represents the desired type of system information.

### BACKGROUND OF THE PRESENT INVENTION

1. Technical Field of the Present Invention

This invention relates generally to information management of processes executing on a computer node within a multi-node network, and, more particularly, to distribution of process-related information throughout a multi-node network.

2. Description of the Related Art

There will now be provided a discussion of various topics to provide a proper foundation for understanding the present invention.

Typically, distributed systems are comprised of central servers and a plurality of nodes. In many instances, servers and nodes are grouped into clusters for reasons of communication load distribution, storage allocation and security. The processes (e.g., computational tasks) executed on each node of the network generate various results, including process-related information that may or may not be of interest to other the processes executing in the distributed computing environment. In order to synchronize or monitor processes locally within the nodes, within a cluster, or across clusters, there is a need to deliver real-time news messages between nodes and clusters. The content of these news messages can be error messages, file system messages, failover information or any other type of process-related information.

In order to distribute news messages between nodes, each process generates news messages and posts them to other processes located in different nodes in the distributed computing environment. Typically, in conventional implementations, a process must manage the news message delivery between the different nodes. Therefore, the process is kept busy with the management of the news message delivery, and thus, the execution time of a computational task within the process slows down. Additionally, each process has to manage a database for the purpose of saving news messages.

Furthermore, nodes in the distributed computing environment can be disrupted by unnecessary messages. For example, if a failure occurs during the execution of one process, the failed process could generate periodic error messages informing the other processes of its failure. These repetitive messages, distributed to the processes executing on other the nodes in the distributed computing environment, may contain information that is useless to executing processes and could possibly disrupt their operation.

Gossip protocols can be used to deliver news messages between nodes. When transferring a news message, each node randomly chooses a partner node with which to communicate. A node simply sends news messages to its corresponding partner node and does not wait for an acknowledgment signal from the partner node or, if a node has failed, for a recovery action. Hence, there is no need for failure detection or specific recovery actions. Nodes achieve fault-tolerance by receiving copies of a news message from different nodes.

Usually, however, the number of news messages that gossip protocols send between partner nodes is fixed. Additionally, a gossip protocol does not attain high reliability in a distributed computing environment in which links can fail for long periods of time. Hence, for applications that require timely delivery, the gossip protocols may not be useful since they are based on eventual, rather than timely, delivery of news messages. Gossip protocols also do not provide updates regarding changes in the topology of a cluster.

It would be an advantageous to implement a system capable of providing real-time news services to various nodes in a cluster. It would be further advantageous if the system filters duplicative news messages and keeps track of historical news messages.

### SUMMARY OF THE PRESENT INVENTION

The present invention has been made in view of the above circumstances and to overcome the above problems and limitations of the prior art.

Additional aspects and advantages of the present invention will be set forth in part in the description that follows and in part will be obvious from the description, or may be learned by practice of the present invention. The aspects and advantages of the present invention may be realized and attained by means of the instrumentalities and combinations particularly pointed out in the appended claims.

A first aspect of the present invention provides a network for distributing news messages that comprises at least two agents. Each of the agents executes on a node in the network, Furthermore, each agent is capable of distributing news messages between the nodes in the network and if capable of receiving news messages from other agents executing in the network. The network further comprises at least two news loggers. In addition, a first communications link is coupled between the agents and a second communications link is coupled between the news loggers and the agents. As further provided by the first aspect of the present invention, each agent further comprises a subscription database, a news service, a distribution unit and a news environment. The news environment of an agent comprises an initialization thread, a receiving thread, a sending thread and a synchronization thread. When a news message is distributed, the validity of the news message is checked, and if the news message is valid, it is saved in the subscription database and sent to the news loggers. The agent waits for an acknowledgement signal from the news loggers, and sends the valid news message to other designated agents. When a news message is received, the validity of the incoming news message is checked, and a valid news message is sent to the distribution unit. From there, the valid news message is distributed to various processes.

A second aspect of the present invention provides a method for handling news messages using a network comprised of at least two agents. Each agent executes on a node within the network and the network further comprises at least two news loggers. The method comprises distributing the news messages, and receiving the news messages. As further provided by the second aspect of the present invention, each agent further comprises a subscription database, a news service, a distribution unit and a news environment. The news environment of an agent comprises an initialization thread, a receiving thread, a sending thread and a synchronization thread. The method further provides that, when a news message is distributed, the validity of the news message is checked, and if the news message is valid, it is saved in the subscription database and sent to the news loggers. As provided by the method, the agent waits for an acknowledgement signal from the news loggers, and sends the valid news message to other designated agents. The method further provides that, when a news message is received, the validity of the incoming news message is checked, and a valid news message is sent to the distribution unit. From there, the method distributes the valid news message to various processes.

A third aspect of the present invention provides a computer software product for handling news messages using a network comprised of at least two agents. Each agent executes on a node within the network and the network further comprises at least two news loggers. The computer software product comprises software instructions for enabling the network to perform predetermined operations, and a computer readable medium bearing the software instructions. The predetermined operations on the computer software product enable the network to distribute the news messages, and receive news messages as well. As further provided by the third aspect of the present invention, the predetermined operations provide each agent with a subscription database, a news service, a distribution unit and a news environment. The news environment of an agent comprises an initialization thread, a receiving thread, a sending thread and a synchronization thread. The predetermined operations further provide that, when a news message is distributed, the validity of the news message is checked, and if the news message is valid, it is saved in the subscription database and sent to the news loggers. As provided by the predetermined operations, the agent waits for an acknowledgement signal from the news loggers, and sends the valid news message to other designated agents. The predetermined operations further provide that, when a news message is received, the validity of the incoming news message is checked, and a valid news message is sent to the distribution unit. From there, the predetermined operations distribute the valid news message to various processes.

A fourth aspect of the invention provides a computer system adapted for handling news messages. The computer system comprises a network having at least two agents. Each agent executes on a node within the network and the network further comprises at least two news loggers. The computer system further comprises a memory with software instructions adapted to enable the computer system to distribute the news messages, and receive news messages as well. As further provided by the fourth aspect of the present invention, the software instructions are adapted to provide each agent with a subscription database, a news service, a distribution unit and a news environment. The news environment of an agent comprises an initialization thread, a receiving thread, a sending thread and a synchronization thread. The software instructions are further adapted to provide that, when a news message is distributed, the validity of the news message is checked, and if the news message is valid, it is saved in the subscription database and sent to the news loggers. As provided by the software instructions, the agent waits for an acknowledgement signal from the news loggers, and sends the valid news message to other designated agents. The software instructions are further adapted to provide that, when a news message is received, the validity of the incoming news message is checked, and a valid news message is sent to the distribution unit. From there, the software instructions distribute the valid news message to various processes.

The above aspects and advantages of the present invention will become apparent from the following detailed description and with reference to the accompanying drawing figures.

### BRIEF DESCRIPTION OF THE DRAWINGS

The accompanying drawings, which are incorporated in and constitute a part of this specification, illustrate the present invention and, together with the written description, serve to explain the aspects, advantages and principles of the present invention. In the drawings,

FIG. 1 is an exemplary diagram of a typical cluster capable of embodying the method of the present invention;

FIG. 2 is a schematic diagram of an agent;

FIG. 3 is an exemplary flow chart for posting news message from a process;

FIG. 4 is an exemplary flow chart for receiving a news message by a process;

FIG. 5 is an exemplary diagram of category tree;

### DETAILED DESCRIPTION OF THE PRESENT INVENTION

Prior to describing the aspects of the present invention, some details concerning the prior art will be provided to facilitate the reader's understanding of the present invention and to set forth the meaning of various terms.

As used herein, the term “computer system” encompasses the widest possible meaning and includes, but is not limited to, standalone processors, networked processors, mainframe processors, and processors in a client/server relationship. The term “computer system” is to be understood to include at least a memory and a processor. In general, the memory will store, at one time or another, at least portions of executable program code, and the processor will execute one or more of the instructions included in that executable program code.

As used herein, the terms “predetermined operations,” the term “computer system software” and the term “executable code” mean substantially the same thing for the purposes of this description. It is not necessary to the practice of this invention that the memory and the processor be physically located in the same place. That is to say, it is foreseen that the processor and the memory might be in different physical pieces of equipment or even in geographically distinct locations.

As used herein, the terms “media,” “medium” or “computer-readable media” include, but is not limited to, a diskette, a tape, a compact disc, an integrated circuit, a cartridge, a remote transmission via a communications circuit, or any other similar medium useable by computers. For example, to distribute computer system software, the supplier might provide a diskette or might transmit the instructions for performing predetermined operations in some form via satellite transmission, via a direct telephone link, or via the Internet.

Although computer system software might be “written on” a diskette, “stored in” an integrated circuit, or “carried over” a communications circuit, it will be appreciated that, for the purposes of this discussion, the computer usable medium will be referred to as “bearing” the instructions for performing predetermined operations. Thus, the term “bearing” is intended to encompass the above and all equivalent ways in which instructions for performing predetermined operations are associated with a computer usable medium.

Therefore, for the sake of simplicity, the term “program product” is hereafter used to refer to a computer-readable medium, as defined above, which bears instructions for performing predetermined operations in any form.

As used herein, the term “process” is a computational task executing on a computer node. The term “news” is information related to a process, including, but not limited to, error messages, file system messages, fail-over information or any other process-related information. The term “message” is information made available by one process to another process. The term “node” is a single station within a network and may be a host, a server, a storage device or a computer. The term “cluster” is a group of nodes within a network computer. The term “subscriber” may be a process executing on a node, a node within a cluster, or a cluster within a network, and that has subscribed for some or all of the news.

A detailed description of the aspects of the present invention will now be given referring to the accompanying drawings.

The present invention provides for handling news messages. News messages are used for synchronization between processes executing within a node, synchronization between processes executing within a cluster, and synchronization between processes executing across clusters. In addition, news messages are used for failover message, error messages and the likes. The present invention manages news messages by using a news agent. A news agent manages news messages by distributing news messages to subscribing processes, as well as executing queries on behalf of subscribers.

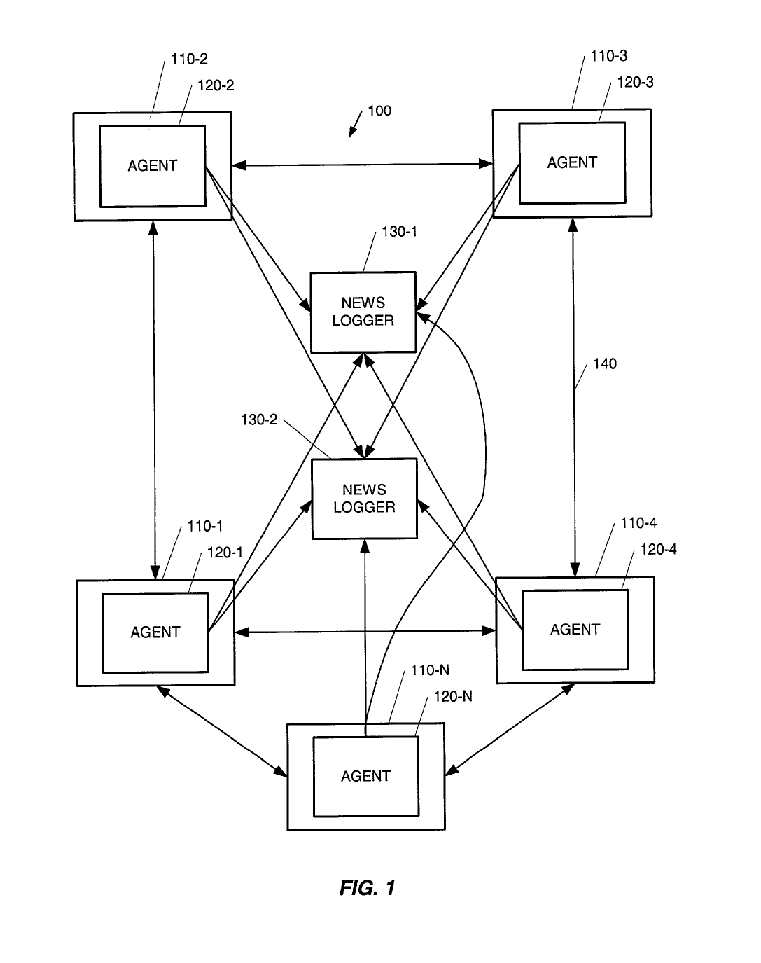

Referring to FIG. 1, an exemplary computer cluster 100 comprising N nodes 110-1 through 110-N, is shown, wherein N represents the number of nodes in the exemplary computer cluster 100. Each node 110 contains a news agent 120, where node 110-1, 110-2, 110-3, 110-4, 110-N contain news agents 120-1, 120-2, 120-3, 120-4, 120-N, respectively. Cluster 100 further comprises at least two news loggers 130-1, 130-2. The news loggers 130-1, 130-2 provide redundancy to ensure reliable messaging between the nodes 110-1, 110-2, 110-3, 110-4, 110-N in case of certain system failures. The news logger 130 stores all of the news messages transferred between nodes 110-1, 110-2, 110-3, 110-4, 110-N for the purpose of synchronization between the news agents 120-1, 120-2, 120-3, 120-4, 120-N. The news loggers 130 and the new agents 120 communicate via a common communication link 140. The common communication link 140 can comprise, but is not limited to, a local area network (LAN), a wide area network (WAN), an Infiniband network or a peripheral component interface (PCI) network, and other.

Communication between the news loggers 130 and the news agents 120 is established using unicast protocols. A unicast protocol is used for sending packets to a single node within a network. The news agents 120-1, 120-2, 120-3, 120-4, 120-N communicate between themselves by using multicast protocols. A multicast protocol is used for sending packets addressed to multiple nodes.

Messages are distributed from a specific news agent only to other news agents belonging to its group. Each group is defined using the standard Internet Group Manage Protocol (IGMP). IGMP allows news message broadcasters to send news messages to a large number of nodes, while traffic is sent only to a Group Destination Address (GDA). The new agents 120 use IGMP to register themselves as receivers of certain multicast groups. The multicast traffic influences only those receivers that are registered to a specific GDA. A person skilled in the art could easily implement such a system by using other protocols for distributing information via network.

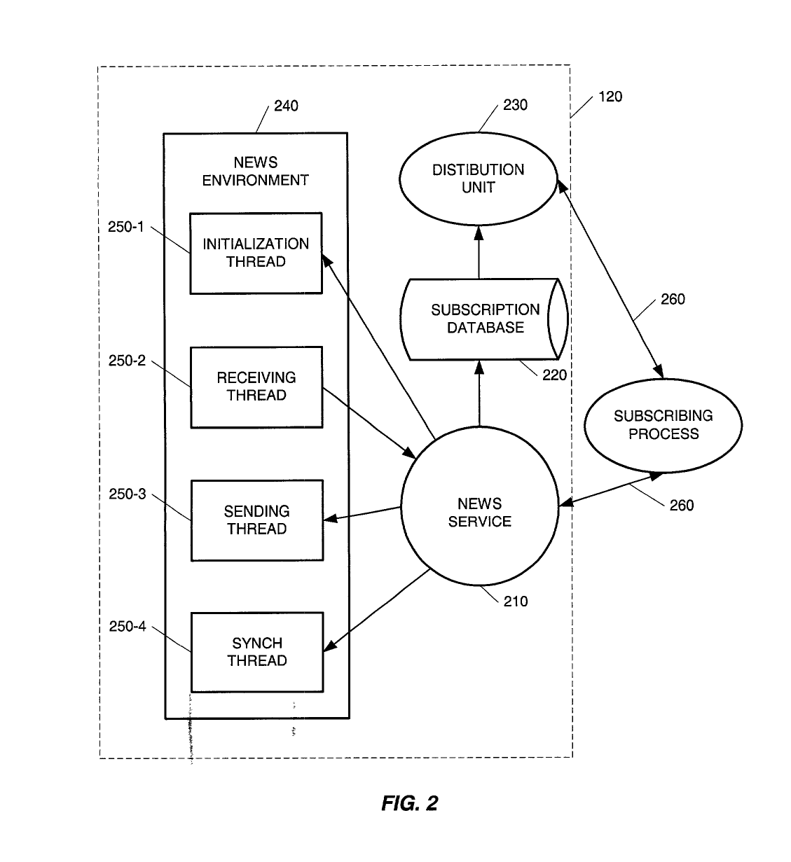

Referring to FIG. 2, an exemplary embodiment of a news agent 120 is illustrated. The news agent 120 is comprised of a news service 210, a subscription database 220, a distribution unit 230 and a news environment 240. The news environment 240 executes a variety of threads for the purpose of interfacing with other news agents. The threads include, but not limited to, a an initialization thread 250-1, a receiving thread 250-2, a sending thread 250-3 and a synchronizing thread 250-41. The news service 210 is the core of the news agent 120, and manages all of the activities for subscribers, including sending news messages and querying the database. A subscribing process and the news service 210 communicate using a First In First Out (FIFO) interface channel 260.

In the FIFO channel 260, a process registers in order to receive news messages, and news messages are sent to registered processes according to the order of message arrival. Initially, the news service 210 creates the subscription database 220 by allocating memory. The allocated memory can be cache memory, RAM memory, flash memory, disk, hard disk, or any other read-write electronic memory used for temporary storage of data. Using the synchronization thread 250-4, the news service 210 monitors neighboring news agents. The news agent neighbors are defined by using standard protocols for multicasting groups (i.e., IGMP, Internet group management protocol) as explained above. The news service 210 also monitors subscriber processes using the FIFO channel 260. Only registered processes may send or received messages through the FIFO channel 260.

The news agent 120 provides news services to processes executing within a node, to processes executing within a cluster, and to processes executing across clusters. Using the news agent 120, a process may subscribe to a news category, query the subscriber database 220, or post news messages for possible use by other processes. A process that is interested in specific information (to be provided in a form of a news message) contacts the news services 210 via the FIFO channel 260, and transmits a subscription command. The interested process also passes its process-identification, which is unique process identification within the FIFO channel 260. The subscription command also updates the subscription database 220, if it is indexed by category and subcategories, such that a category/subcategory in the subscription database 220 points to a subscriber. Each subscriber chooses categories/subcategories from a category tree namespace according to the desired information. A process chooses categories automatically according to its tasks' requirements. For example, fail-over news messages will be in a category responsible for handling fail-over messages.

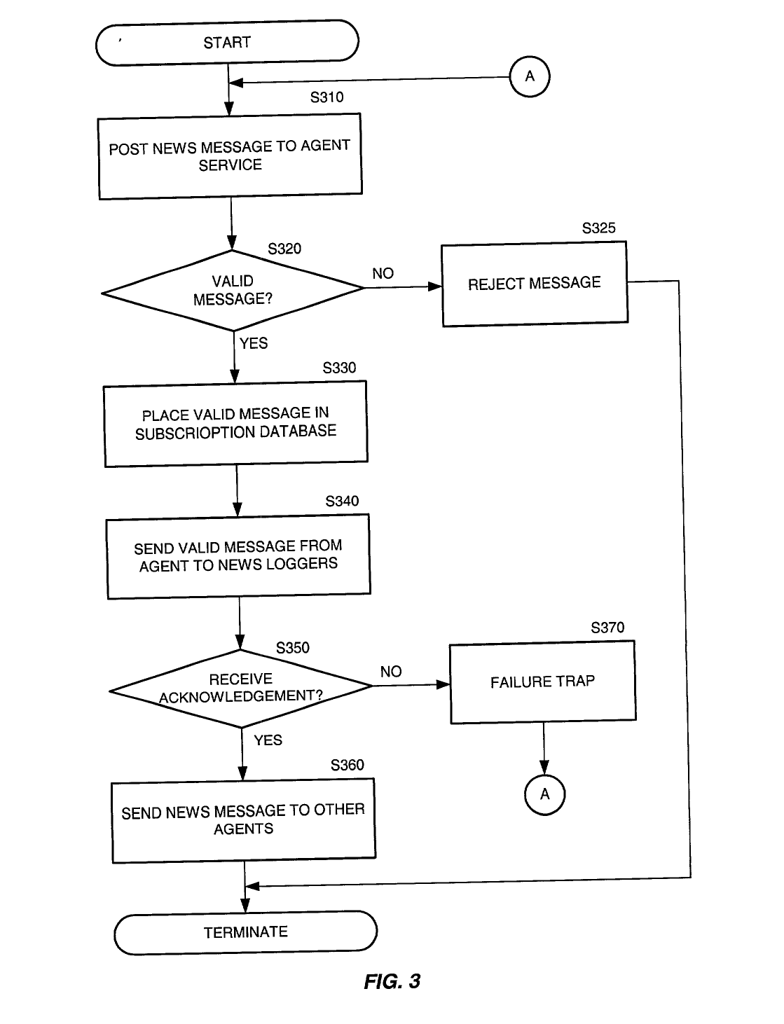

Referring to FIG. 3, an exemplary process flow for the posting news messages is illustrated. At S310, a process informs the news service 210 that there is a news message to distribute. The process passes a post command through the FIFO channel 260 to the news service 210. A news message comprises the following fields: news category, node identification, process identification and data. Generally, the node identification field is a unique number, or sequence of alphanumeric characters, given to each node. Similarly, the process identification field is a unique number, or sequence of alphanumeric characters, given to each process executed within a node.

At S320, the news service 210 receives news message and performs validity checks on the received news message. For example, these checks could verify if a news message arrived from a known process, if the news message corresponded to a valid category, or if the news message is a duplicative of a previously received news message. At S325, the news service 210 rejects all invalid messages and does not distribute them.

At S330, only valid messages are saved in the subscription database 220. If subscription database 220 is full, then a message will be dropped out of the subscription database 220. Dropping algorithms can comprise, but are not limited to, random, first in first out, or least recently used (LRU). Alternatively, a message may be deleted using a time-to-live (TTL) approach, where each messages includes a time counter indicating the length of time a message is allowed to survive before being discarded.

At S340, the news service 210, using the synchronizing thread 250-4, sends a message by means of unicast protocols to the news loggers 130. At S350, the news service waits for an acknowledgement signal from the news logger 130. At S360, if the news logger 130 returns an acknowledgement signal, then the news service 210 distributes the message to all of its neighbors as multicast messages, using sending thread 250-3. The news message is distributed via the common communications link 140, and every node with a news agent that is subscribed to the news item will pickup the message. If news loggers 130 do not return an acknowledgement signal, at S370, then a failure trap sub-procedure is executed. This failure trap sub-procedure attempts to synchronize with news loggers 130. In case the news loggers 130 do not respond, then the process of distributing a message from the news agent 120 is restarted. It should be noted that when restarting a single the news agent 120, the other the news agents are not infected.

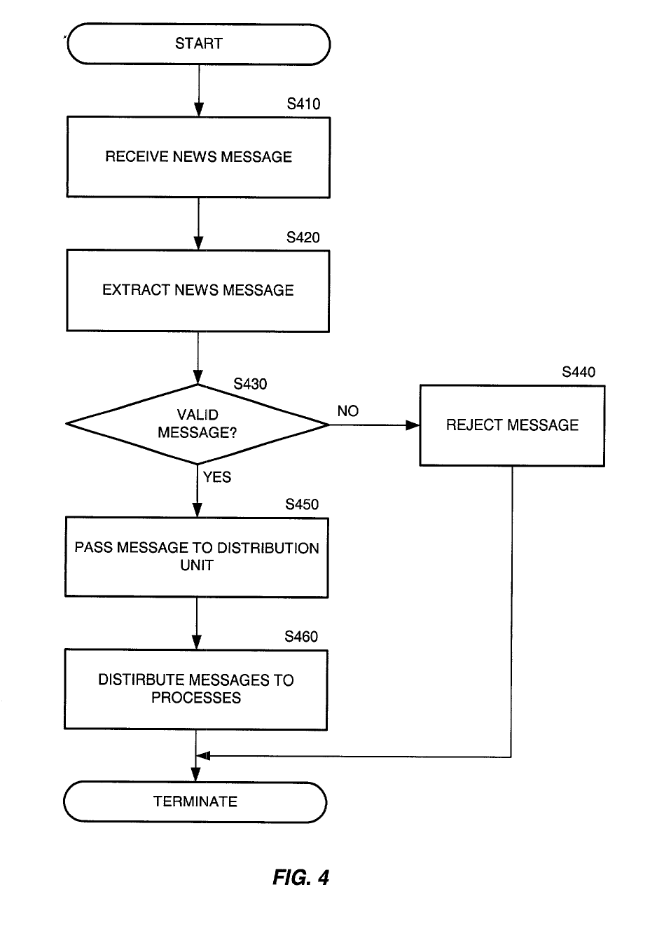

Referring to FIG. 4, an exemplary process flow of receiving a message by news agent 120 is illustrated. A S410, a node in a cluster receives a news message and passes it to its corresponding news agent. For example, if node 110-1 received a news message, it would be passed to its news agent 120-1. The news agent 120-1 picks up messages using the receiving thread 250-2. At S420, the receiving thread 250-2 parses the message, and extracts the news message from it. At S430, the news services 210 performs validity checks on the incoming news message. For example, these checks could verify if a message arrived from a known source, whether the message corresponds to a valid category, or if that message is a duplicative of a previously received message.

At S440, invalid messages are rejected by the news service 210 and are ignored. Valid news messages are saved in the subscription database 220 and passed to the distribution unit 230. At S450, the distribution unit 230 searches for subscribers according to news message category in the subscription database 220. At S460, for each subscriber that is found, the distributor unit 230 pushes the news message to the subscriber using the FIFO channel 260.

Additionally, a process has the capability to check for past news messages using queries. A process will command the news service 210 to perform queries of the subscription database 220 through the FIFO channel 260. For example, a query may be based on a category, a keyword, node identification and/or process identification. The news service 210 searches the subscription database 220 for news messages matching the query. All matching results are sent to a process via FIFO channel 260. The matching results can include messages from sub-categories related to the requested category.

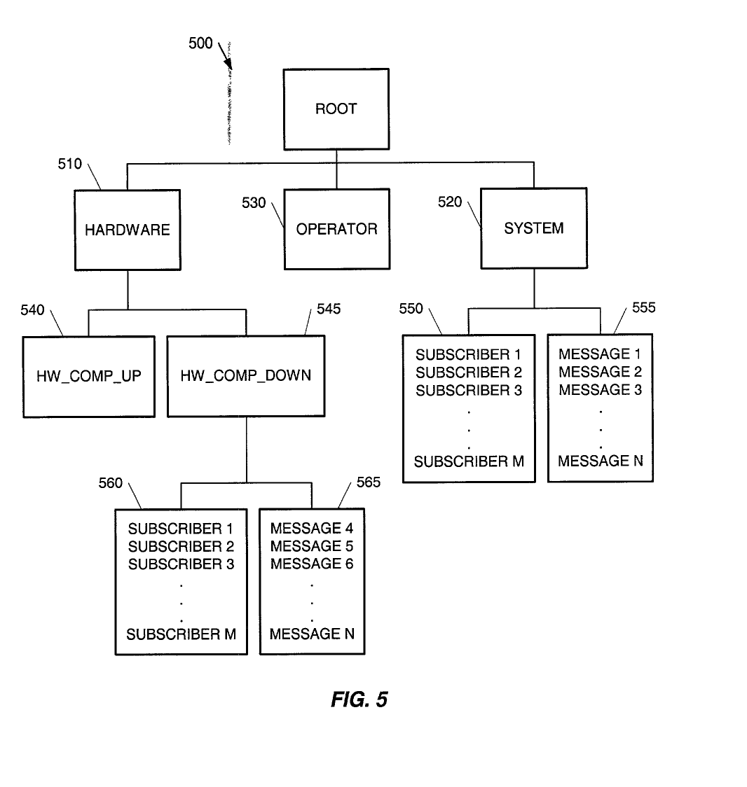

Referring to FIG. 5, an exemplary implementation of a subscription database 200 as category tree 500 is illustrated. The subscription database 220 is arranged in a category tree structure 500, where each node in the tree represents a category. A category includes an array of pointers, which point to subcategories, or to a list of subscribers and a list of messages. In FIG. 5, there are shown examples of three main categories. The hardware category 510 indicates messages relating to hardware, and further points to a subcategory 540 called “HW_COMP_DOWN” and a sub-category 545 called “HW_COMP_UP”, which correspond to hardware pieces that are non-functional and functional, respectively. Subcategory 545 points to a list of subscribers 560 and a list of news messages 565. Subscriber list 560 includes N subscribers who have requested information relating to the subcategory 540 “HW_COMP_DOWN”.

Under this subcategory 545, there are N news messages arranged in message list 565. News messages in the message list 565 may be news messages indicating hardware status, hardware utilization, etc. Registered subscribers from the subscriber list 560 will receive all messages from the message list 565. The category 520 does not have subcategories, and handles a subscriber list 550 and a message list 555 in the manner described above. The category 530 is an example of an empty category; hence, it is not pointing to any subcategories, subscribers or messages.

In another exemplary embodiment of the present invention, a computer software product for handling news messages using a network comprised of at least two agents is provided. Each agent executes on a node within the network and the network further comprises at least two news loggers. The computer software product comprises software instructions for enabling the network to perform predetermined operations, and a computer readable medium bearing the software instructions. The predetermined operations on the computer software product enable the network to distribute the news messages, and receive news messages as well.

As described above, the news messages comprise messages generated by a process executing on a node. The predetermined operations borne on the computer program product provide each agent with a subscription database, a news service, a distribution unit and a news environment. In the exemplary embodiment, the subscription database is organized as a category tree. As illustrated in FIG. 5, each category in the category tree can comprise one or more subcategories. Typically, a category in the category tree comprises a process list and a message list.

The predetermined operations further provide that, when a news message is distributed, the validity of the news message is checked, and if the news message is valid, it is saved in the subscription database and sent to the news loggers. In order to store a fresh news message, the predetermined operations drop older news messages from the subscription database if the database is full. As provided by the predetermined operations, the agent waits for an acknowledgement signal from the news loggers, and sends the valid news message to other designated agents when it receives the acknowledgement signal from the news loggers. When a news message is received, predetermined operations check the validity of the incoming news message, and a valid news message is sent to the distribution unit. From there, the predetermined operations distribute the valid news message to various processes.

For an agent, the predetermined operations provide a news environment comprised of an initialization thread, a receiving thread, a sending thread and a synchronization thread. The synchronizing thread is used for sending valid news messages to the news loggers, since the news loggers are used for synchronization between agents. The sending thread is used for sending the valid news messages to designated agents. The receiving thread is used for receiving news messages from other agents. The initializing thread is used to initialize an agent, which includes creating the subscription database, and registering at least one process for news services.

In another exemplary embodiment of the present invention, a computer system adapted for handling news messages is provided. The computer system comprises a network having at least two agents. Each agent executes on a node within the network and the network further comprises at least two news loggers. The computer system further comprises a memory with software instructions adapted to enable the computer system to distribute the news messages, and receive news messages as well.

As described above, the news messages comprise messages generated by a process executing on a node. The software instructions are adapted so that the computer system provides each agent with a subscription database, a news service, a distribution unit and a news environment. In the exemplary embodiment, the subscription database is organized as a category tree. As illustrated in FIG. 5, each category in the category tree can comprise one or more subcategories. A category in the category tree comprises a process list and a message list, as well as other items that may be of interest to the various processes that receive the news messages.

The software instructions are further adapted such that the computer system provides that, when a news message is distributed, the validity of the news message is checked, and if the news message is valid, it is saved in the subscription database and sent to the news loggers. In order to store a fresh news message, the software instructions are adapted to drop older news messages from the subscription database if the subscription database is full. As provided by the software instructions, the agent waits for an acknowledgement signal from the news loggers, and sends the valid news message to other designated agents when it receives the acknowledgement signal from the news loggers. When a news message is received, the software instructions are adapted to check the validity of the incoming news message, and a valid news message is sent to the distribution unit. From there, the software instructions are adapted so that the computer system distributes the valid news message to various processes.

For an agent, the software operations are further adapted so that the computer system provides a news environment comprised of an initialization thread, a receiving thread, a sending thread and a synchronization thread. The synchronizing thread is used for sending valid news messages to the news loggers, since the news loggers are used for synchronization between agents. The sending thread is used for sending the valid news messages to designated agents. The receiving thread is used for receiving news messages from other agents. The initializing thread is used to initialize an agent, which includes creating the subscription database, and registering at least one process for news services.

The foregoing description of the aspects of the present invention has been presented for purposes of illustration and description. It is not intended to be exhaustive or to limit the present invention to the precise form disclosed, and modifications and variations are possible in light of the above teachings or may be acquired from practice of the present invention. The principles of the present invention and its practical application were described in order to explain the to enable one skilled in the art to utilize the present invention in various embodiments and with various modifications as are suited to the particular use contemplated.

Thus, while only certain aspects of the present invention have been specifically described herein, it will be apparent that numerous modifications may be made thereto without departing from the spirit and scope of the present invention. Further, acronyms are used merely to enhance the readability of the specification and claims. It should be noted that these acronyms are not intended to lessen the generality of the terms used and they should not be construed to restrict the scope of the claims to the embodiments described therein.

What is claimed is:

1. A network for distributing news messages comprising:
at least two agents, each of said agents executing on a node, and each agent capable of distributing news messages between said nodes and capable of receiving news messages from other agents;
at least two news loggers;
a first communications link coupled between said agents and a second communications link coupled between said news loggers and said agents.

2. The network of claim 1, wherein said news messages comprise at least one message generated by a process executing on said node.

3. The network of claim 2, wherein said news messages are at least one of an error message, a failover message, a synchronization message and a hardware message.

4. The network of claim 1, wherein said node is at least one of a computer host, a computer server, a storage node, a file-system, a location independent file system and a geographically distributed computer system.

5. The network of claim 1, wherein said news logger is a process executing on said node.

6. The network of claim 5, wherein said news logger process further comprises a database for the purpose of backup of said news messages.

7. The network of claim 1, wherein said news loggers are used for synchronizing between said agents.

8. The network of claim 1, wherein said first communications link and said second communications link are at least one of a local area network (LAN), a wide area network (WAN), a peripheral component interconnect (PCI) network, and an InfiniBand network.

9. The network of claim 1, wherein said first communications link and said second communications link are based on at least one of a multicast protocol, a unicast protocol and a broadcast protocol.

10. The network of claim 1, wherein said agent further comprises:
a subscription database;
a news service;
a distribution unit; and
a news environment.

11. The network of claim 10, wherein said news messages are saved in said subscription database.

12. The network of claim 10, wherein said news environment comprises:
an initialization thread;
a receiving thread;
a sending thread; and
a synchronization thread.

13. The network of claim 10, wherein said subscription database is stored on at least one of a RAM memory, a flash memory, a cache memory, a disk, and a hard disk.

14. The network of claim 10, wherein data in said subscription database is organized as a category tree.

15. The network of claim 14, wherein a category in said category tree comprises one or more subcategories.

16. The network of claim 14, wherein a category in said category tree comprises a process list and a message list.

17. The network of claim 10, wherein said distributing news messages further comprises:
checking the validity of said news messages;
saving valid news messages in said subscription database;
sending said valid news messages to said news loggers;
waiting for an acknowledgement signal from said news loggers;
sending said valid news messages to designated agents.

18. The network of claim 17, wherein checking the validity of said news messages comprises checking if the news message was received from a known process or checking if the news message is a duplicate of a previously received message.

19. The network of claim 17, wherein saving valid news messages in said subscription database comprises dropping an older news message with a newer news message if said database is full.

20. The network of claim 19, wherein dropping news messages is performed by a least recently used algorithm, a random algorithm, a first-in first-out algorithm, a time-to-live algorithm, or a round robin algorithm.

21. The network of claim 17, wherein said agents wait for an acknowledgement signal from said news loggers for a predetermined amount of time.

22. The network of claim 17, wherein a unicast protocol is used for sending said valid news messages to said news loggers.

23. The network of claim 17, wherein a multicast protocol is used for sending said valid news messages to designated agents.

24. The network of claim 10, wherein receiving news messages comprises:
checking the validity of incoming news messages;
passing valid news messages to said distribution unit; and
distributing said valid news messages to said processes.

25. The network of claim 24, wherein checking the validity of incoming news messages comprises checking if the news message was received from a known process or checking if the news message is a duplicate of a previously received message.

26. The network of claim 24 wherein distributing said valid news messages to said processes comprises:
searching said database for processes who requested said news messages; and
sending said valid news messages to said requesting processes.

27. The network of claim 10, wherein said agent is capable of providing historical information.

28. The network of claim 27, wherein providing historical information comprises:
querying said subscription database;
sending the query results to said process.

29. A method for handling news messages using a network comprising of at least two agents, wherein each agent executes on a node, and at least two news loggers, wherein the method comprises:
distributing said news messages; and
receiving said news messages.

30. The method of claim 29, the method further comprises:
initializing each of said agents; and
providing historical information.

31. The method of claim 29, wherein said news messages comprise messages generated by a process executing on said node.

32. The method of claim 31, wherein said news messages are at least one of an error message, a failover message, a synchronization message and a hardware message.

33. The method of claim 29, wherein said node is at least one of a computer host, a computer server, a storage node, a file-system, a location independent file system and a geographically distributed computer system.

34. The method of claim 29, wherein said news logger is a process executing on said node.

35. The method of claim 34, wherein said process further comprises a database.

36. The method of claim 35, wherein said database backs up said news messages.

37. The method of claim 29, wherein said news loggers are used for synchronizing between said agents.

38. The method of claim 29, wherein each of said agents further comprises:
a subscription database;
a news service;
a distribution unit; and
a news environment.

39. The method of claim 38, wherein said subscription database backs up said news messages.

40. The method of claim 38, wherein said news environment comprises:
an initialization thread;
a receiving thread;
a sending thread; and
a synchronization thread.

41. The method product of claim 39, wherein said subscription database is organized as a category tree.

42. The method of claim 41, wherein a category in said category tree comprises one or more subcategories.

43. The method of claim 42, wherein a category in said category tree comprises a process list and a message list.

44. The method of claim 43, wherein said subscription database is stored on at least one of a RAM memory, a flash memory, a cache memory, a disk, and a hard disk.

45. The method of claim 29, wherein said process is a computational task executing on said node.

46. The method of claim 40, wherein said distributing news messages comprises:
receiving said news messages from said process;
checking the validity of said news messages;
saving valid news messages in said subscription database;
sending said valid news messages to said news loggers;
waiting for acknowledgement signal from said news loggers; and
sending said valid news messages to designated agents.

47. The method of claim 46, wherein receiving said news messages from said process uses said news service.

48. The method of claim 46, wherein checking the validity of said news messages comprises checking if the news message was received from a known process or checking if the news message is a duplicate of a previously received message.

49. The method of claim 46, wherein saving valid news messages in said subscription database comprises dropping an older news message with a newer news message if said database is full.

50. The method of claim 49, wherein dropping news messages is performed by a least recently used algorithm, a random algorithm, a first-in first-out algorithm, a time-to-live algorithm, or a round robin algorithm.

51. The method of claim 46, wherein said agents wait for an acknowledgement signal from said news loggers for a predetermined amount of time.

52. The method of claim 46, wherein said synchronizing thread is used for sending said valid news messages to said news loggers.

53. The method of claim 46, wherein said sending thread is used for sending said valid news messages to designated agents.

54. The method of claim 40, wherein said receiving news messages comprises:
receiving said news messages from said agents;
extracting incoming news messages;
checking the validity of said incoming news messages;
passing valid news messages to said distribution unit; and
distributing said valid news messages to a process.

55. The method of claim 54, wherein receiving said news messages from said agents uses said receiving thread.

56. The method of claim 54, wherein checking the validity of said incoming news messages comprises checking if the news message was received from a known process or checking if the news message is a duplicate of a previously received message.

57. The method of claim 54, wherein distributing said valid news messages to a process comprises:
searching in said subscription database for processes who requested for said news messages; and
sending said valid news messages to said processes.

58. The method of claim 40, wherein initializing an agent comprises:
creating a subscription database; and
registering at least a process for news services.

59. The method of claim 58, wherein creating a database comprises allocating memory.

60. The method of claim 58, wherein registering a process for news services comprises that each said process register to at least one category in said database.

61. The method of claim 40, wherein providing historical information comprises:
querying said subscription database; and
sending query results to said process that requested the query.

62. A computer software product for handling news messages using a network comprising at least two agents, wherein each agent executes on a node, and at least two news loggers, said computer software product comprises:
software instructions for enabling said network to perform predetermined operations, and a computer readable medium bearing the software instructions, wherein said predetermined operations comprise:
distributing said news messages; and
receiving said news messages.

63. The computer software product of claim 62, said predetermined operations further comprise:
initializing each of said agents; and
providing historical information.

64. The computer software product of claim 62, wherein said news messages comprise messages generated by a process executing on said node.

65. The computer software product of claim 62, wherein said node is at least one of a computer host, a computer server, a storage node, a file-system, a location independent file system and a geographically distributed computer system.

66. The computer software product of claim 62, wherein said news logger is a process executing on said node.

67. The computer software product of claim 66, wherein said process comprises a database.

68. The computer software product of claim 67, wherein said database backs up said news messages.

69. The computer software product of claim 62, wherein said news loggers are used for synchronization between said agents.

70. The computer software product of claim 62, wherein each of said agents further comprises:
a subscription database;
a news service;
a distribution unit; and
a news environment.

71. The computer software product of claim 70, wherein said subscription database saves said news messages.

72. The computer software product of claim 70, wherein said news environment comprises:
an initialization thread;
a receiving thread;
a sending thread; and
a synchronization thread.

73. The computer software product of claim 71, wherein said database is organized as a category tree.

74. The computer software product of claim 73, each category in said category tree comprises one or more subcategories.

75. The computer software product of claim 74, wherein a category in said category tree comprises a process list and a message list.

76. The computer software product of claim 75, wherein said subscription database is stored on at least one of a RAM memory, a flash memory, a cache memory, a disk, and a hard disk.

77. The computer software product of claim 62, wherein said process is a computational task executing on said node.

78. The computer software product of claim 72, wherein said distributing news messages comprises:
receiving said news messages from said process;
checking the validity of said news messages;
saving valid news messages in said subscription database;
sending said valid news messages to said news loggers;
waiting for acknowledgement signal from said news loggers; and
sending said valid news messages to designated agents.

79. The computer software product of claim 78, wherein said news service is used for receiving said news messages from said process.

80. The computer software product of claim 78, wherein checking the validity of said news messages comprises checking if the news message was received from a known process or checking if the news message is a duplicate of a previously received message.

81. The computer software product of claim 78, wherein saving valid news messages in said subscription database comprises dropping an older news message with a newer news message if said database is full.

82. The computer software product of claim 81, wherein dropping news messages is performed by a least recently used algorithm, a random algorithm, a first-in first-out algorithm, a time-to-live algorithm, or a round robin algorithm.

83. The computer software product of claim 78, wherein said agents wait for an acknowledgement signal from said news loggers for a predetermined amount of time.

84. The computer software product of claim 78, wherein said synchronizing thread is used for sending said valid news messages to said news loggers.

85. The computer software product of claim 78, wherein said sending thread is used for sending said valid news messages to designated agents.

86. The computer software product of claim 78, wherein said receiving news messages further comprises:
receiving said news messages from said agents;
extracting incoming news messages;
checking the validity of said incoming news messages;
passing valid news messages to said distribution unit; and
distributing said valid news messages to a process.

87. The computer software product of claim 86, wherein receiving said news messages from said agents uses said receiving thread.

88. The computer software product of claim 86, wherein checking the validity of said incoming news messages comprises checking if the news message was received from a known process or checking if the news message is a duplicate of a previously received message.

89. The computer software product of claim 86, wherein distributing said valid news messages to a process comprises:
searching in said subscription database for processes who requested for said news messages; and
sending said valid news messages to said processes.

90. The computer software product of claim 72, wherein initializing an agent comprises:
creating a subscription database; and
registering at least a process for news services.

91. The computer software product of claim 90, wherein creating a database comprises allocating memory.

92. The computer software product of claim 90, wherein registering a process for news services comprises that each said process register to at least one category in said database.

93. The computer software product of claim 72, wherein providing historical information comprises:
querying said subscription database; and
sending query results to said process that requested query.

94. A computer system adapted for handling news messages, the computer system comprising:
a network comprising at least two agents, wherein each agent executes on a node in the computer system, and at least two news loggers;
a memory comprising software instructions adapted to enable the computer system to:
distribute said news messages; and
receive said news messages.

95. The computer system of claim 94, said software instructions being further adapted to enable the computer system to:
initialize each of said agents; and
provide historical information.

96. The computer system of claim 94, wherein said news messages comprise messages generated by a process executing on said node.

97. The computer system of claim 94, wherein said node is at least one of a computer host, a computer server, a storage node, a file-system, a location independent file system and a geographically distributed computer system.

98. The computer system of claim 94, wherein said news logger is a process executing on said node.

99. The computer system of claim 98, wherein said process comprises a database.

100. The computer system of claim 99, wherein said database backs up said news messages.

101. The computer system of claim 95, wherein said news loggers are used for synchronization between said agents.

102. The computer system of claim 95, wherein each of said agents further comprises:
a subscription database;
a news service;
a distribution unit; and
a news environment.

103. The computer system of claim 102, wherein said subscription database saves said news messages.

104. The computer system of claim 102, wherein said news environment comprises:
an initialization thread;
a receiving thread;
a sending thread; and
a synchronization thread.

105. The computer system of claim 103, wherein said database is organized as a category tree.

106. The computer system of claim 105, each category in said category tree comprises one or more subcategories.

107. The computer system of claim 106, wherein a category in said category tree comprises a process list and a message list.

108. The computer system of claim 107, wherein said subscription database is stored on at least one of a RAM memory, a flash memory, a cache memory, a disk, and a hard disk.

109. The computer system of claim 94, wherein said process is a computational task executing on said node.

110. The computer system of claim 104, wherein said distributing news messages comprises:
receiving said news messages from said process;
checking the validity of said news messages;
saving valid news messages in said subscription database;
sending said valid news messages to said news loggers;
waiting for acknowledgement signal from said news loggers; and
sending said valid news messages to designated agents.

111. The computer system of claim 78, wherein said news service is used for receiving said news messages from said process.

112. The computer system of claim 110, wherein checking the validity of said news messages comprises checking if the news message was received from a known process or checking if the news message is a duplicate of a previously received message.

113. The computer system of claim 110, wherein saving valid news messages in said subscription database comprises dropping an older news message with a newer news message if said database is full.

114. The computer system of claim 113, wherein dropping news messages is performed by a least recently used algorithm, a random algorithm, a first-in first-out algorithm, a time-to-live algorithm, or a round robin algorithm.

115. The computer system of claim 110, wherein said agents wait for an acknowledgement signal from said news loggers for a predetermined amount of time.

116. The computer system of claim 110, wherein said synchronizing thread is used for sending said valid news messages to said news loggers.

117. The computer system of claim 110, wherein said sending thread is used for sending said valid news messages to designated agents.

118. The computer system of claim 110, wherein said receiving news messages further comprises:
receiving said news messages from said agents;
extracting incoming news messages;
checking the validity of said incoming news messages;
passing valid news messages to said distribution unit; and
distributing said valid news messages to a process.

119. The computer system of claim 118, wherein receiving said news messages from said agents uses said receiving thread.

120. The computer system of claim 118, wherein checking the validity of said incoming news messages comprises checking if the news message was received from a known process or checking if the news message is a duplicate of a previously received message.

121. The computer system of claim 118, wherein distributing said valid news messages to a process comprises:
searching in said subscription database for processes who requested for said news messages; and
sending said valid news messages to said processes.

122. The computer system of claim 104, wherein initializing an agent comprises:
creating a subscription database; and
registering at least a process for news services.

123. The computer system of claim 122, wherein creating a database comprises allocating memory.

124. The computer system of claim 122, wherein registering a process for news services comprises that each said process register to at least one category in said database.

125. The computer system of claim 104, wherein providing historical information comprises:
querying said subscription database; and
sending query results to said process that requested query.
